(19) United States
(12) Patent Application Publication
(10) Pub. No.: US 2012/0061434 A1
(43) Pub. Date: Mar. 15, 2012

(54) REAR RACK WITH ADJUSTABLE FIXATION ARMS

(76) Inventors: Patrick GIGUERE, Ste-Marie (CA); Érick AUGER, Jonquiere (CA); Martin PORTELANCE, Chicoutimi (CA)

(21) Appl. No.: 13/228,581

(22) Filed: Sep. 9, 2011

Related U.S. Application Data
(60) Provisional application No. 61/381,510, filed on Sep. 10, 2010.

(51) Int. Cl. B62J 9/00

(52) U.S. Cl. 224/412

(57) ABSTRACT

An adjustable fixation assembly for a luggage carrier for a wheeled vehicle comprising: a slider having a slider body adapted to receive a portion of the support tube of the luggage carrier, the slider being adapted to slide along a length of the support tube and to rotate about the support tube, the slider having an arm holder; an arm being received in the arm holder of the slider, the arm being extendable between a retracted configuration and an extended configuration with respect to the support tube, a front end of the arm being adapted to be affixed to a frame of the two-wheeled vehicle; a slider tightening assembly adapted to secure a position and orientation of the slider on the support tube; an arm tightening assembly adapted to secure an extension length of the arm in the arm holder.

### CROSS-REFERENCE TO RELATED APPLICATIONS

This application claims priority under 35USC §119(e) of U.S. provisional patent application 61/381,510 filed Sep. 10, 2010, the specification of which is hereby incorporated by reference.

### TECHNICAL FIELD

The invention relates to racks for bicycles, more specifically, it relates to rear racks with adjustable fixation arms.

### BACKGROUND OF THE ART

Historically, all bicycles had a horizontal crossbar or top tube. Consequently, the seat stay eyelets were located at a high level with respect to the top of the rear rack. Most bicycles now have an inclined crossbar or top tube. The seat stay eyelets are therefore lowered with respect to the top of the rack. The prior art rear racks were not adapted following this modification of the angle of the bicycle top tube.

The prior art rear racks for bicycles are currently available in three mounting categories: 1. In most cases, the top portion of the rear rack is attached to the eyelets of the seat stay using two rods, 2. The top portion of the rear rack is attached to the seat stay using a central tongue, 3. The rear rack is attached to the rear brake.

The prior art rear racks for bicycles have different bike attachment systems that have drawbacks. More particularly, prior art rear racks are typically ill-fitted for use on women bikes which have a smaller frame or on bicycle frames which are not equipped with a mounting bracket. It is very difficult to install the rear rack such that the top of the rack, the pannier support area or the top plate rests horizontally. It becomes necessary for users to exercise caution and determination in trying to find a rear rack that can be installed properly on their bicycle. Moreover, there is no standardization of the construction of bicycles and perforations and eyelets, if provided, are located wherever the particular manufacturer may have seen fit on the bicycle frame.

### SUMMARY

According to one broad aspect of the present invention, there is provided a luggage carrier for a wheeled vehicle, comprising: a frame having a top plate surrounding portion and two pairs of support tubes extending downward from the top plate surrounding portion toward one another at both sides of the frame, the pair including a front tube and a rear tube, the two pairs being a left-side pair and a right-side pair; two attachment plates, one for each pair of support tubes, the support tubes ending at the dropout plate and being spaced part by a short distance from one another at the attachment plate; two adjustable fixation assemblies each provided on one front tube of the two pairs of downward extending support tubes, the adjustable fixation assembly being adapted to be displaceable along a height of the front tube and locked at an installation height, the adjustable fixation assembly being extendable between a retracted configuration and an extended configuration and locked at an installation length.

In one embodiment, the luggage carrier has a support top plate for supporting the luggage secured within the top plate surrounding portion of the frame.

According to another broad aspect of the present invention, there is provided a luggage carrier for a wheeled vehicle, comprising: a top plate for supporting said luggage and two support tubes extending downward from the top plate; two dropout plates, one for each support tube, said support tube ending at said dropout plate; two adjustable fixation assemblies each provided on one of said downward extending support tubes, said adjustable fixation assembly being adapted to be attached to and displaceable along a height of said support tube and locked on said support tube at a tube end at an installation height, said adjustable fixation assembly being extendable between a retracted configuration and an extended configuration and adapted to be locked at an installation length and adapted to be attached to a part of said wheeled vehicle at a vehicle end.

According to another broad aspect of the present invention, there is provided a luggage carrier for a wheeled vehicle, comprising: a frame having a top plate surrounding portion and at least one first support tube extending downward from the top plate surrounding portion on a first side of said frame and at least one second support tube extending downward from the top plate surrounding portion on a second side of said frame, said first side being opposed to said second side; two dropout plates, one for each side of said frame, the support tubes on said first side of said frame ending at a first dropout plate, the support tubes on said second side of said frame ending at a second dropout plate; a first adjustable fixation assembly provided on a front tube of said at least one first support tube and a second adjustable fixation assembly provided on a front tube of said at least one second support tube, the first and second adjustable fixation assemblies each being adapted to be displaceable along a height of the respective front tube and locked at an installation height, the adjustable fixation assemblies each being extendable between a retracted configuration and an extended configuration and adapted to be locked at an installation length and adapted to be attached to a part of said wheeled vehicle.

In one embodiment, the luggage carrier further comprises a support top plate for supporting the luggage secured within the top plate surrounding portion of the frame.

According to still another broad aspect of the present invention, there is provided an adjustable fixation assembly for a luggage carrier for a wheeled vehicle, the luggage carrier having at least one support tube extending at least partly between a top and a bottom of the luggage carrier, comprising: a slider having a slider body adapted to receive a portion of the support tube, the slider being adapted to slide along a length of the support tube and to rotate about the support tube, the slider having an arm holder; an arm being received in the arm holder of the slider, the arm being extendable between a retracted configuration and an extended configuration with respect to the support tube, a front end of the arm being adapted to be affixed to a frame of the two-wheeled vehicle; a slider tightening assembly adapted to secure a position and orientation of the slider on the support tube; an arm tightening assembly adapted to secure an extension length of the arm in the arm holder.

### BRIEF DESCRIPTION OF THE DRAWINGS

Having thus generally described the nature of the invention, reference will now be made to the accompanying drawings, showing by way of illustration a preferred embodiment thereof and in which

FIG. 1 includes FIG. 1A and FIG. 1B in which FIG. 1A is a front perspective view of an example rack and FIG. 1B is a rear perspective view of the example rack of FIG. 1A;

FIG. 2 includes FIGS. 2A, 2B, 2C, 2D and 2E which are respectively a right side elevation view (the left side elevation view is a mirror image of the right side elevation view), a rear elevation view, a front elevation view, a top view and a bottom view of the example rear rack of FIG. 1;

FIG. 3 shows an example adjustable fixation assembly for the rear rack of FIG. 1 in the retracted configuration;

FIG. 4 is an exploded view of the slider of the example adjustable fixation assembly of FIG. 3;

FIG. 5 shows the example rear rack of FIG. 1 on which the adjustable fixation assemblies are rotated such that the arms lie vertically;

FIG. 6 shows the example rear rack of FIG. 1 on which the adjustable fixation assemblies are rotated in within the frame of the rear rack for packaging purposes;

FIG. 7 shows the example rear rack of FIG. 1 which is installed above the rear wheel (not shown) of a tall frame 420 of a bicycle 400 (only partly shown) using the adjustable fixation assemblies, in their half-extended configuration, which are attached to the eyelets of the seat stays of the bicycle frame;

FIG. 8 shows the example rear rack of FIG. 1 which is installed above the rear wheel (not shown) of a tall frame 420 of a bicycle 400 (only partly shown) using the adjustable fixation assemblies, in their retracted configuration, which are attached to the brake mounts of the seat stays of the bicycle frame;

FIG. 9 shows the example rear rack of FIG. 1 which is installed above the rear wheel (not shown) of a tall frame 420 of a bicycle 400 (only partly shown) using the adjustable fixation assemblies, in their extended configuration, which are attached to the eyelets of the seat stays of the bicycle frame;

FIG. 10 shows the example rear rack of FIG. 1 which is installed above the rear wheel (not shown) of a small frame 422 of a bicycle 400 (only partly shown) using the adjustable fixation assemblies, in their fully-extended configuration, which are attached to the eyelets of the seat stays of the bicycle frame;

FIG. 11 shows the example rear rack of FIG. 1 which is installed above the rear wheel (not shown) of a small frame 422 of a bicycle 400 (only partly shown) using the adjustable fixation assemblies, in their half-extended configuration, which are attached to the brake mount of the seat stays of the bicycle frame;

FIG. 12 shows another example rear rack which has only two support tubes, one on each side at the rear of the rear rack;

FIG. 13 shows another example rear rack which has a different configuration of support tubes, the adjustable fixation assembly being provided on the front support tube of the V-shaped configuration;

FIG. 14 shows another example adjustable fixation assembly with a telescopic arm.

It will be noted that throughout the appended drawings, like features are identified by like reference numerals.

### DETAILED DESCRIPTION

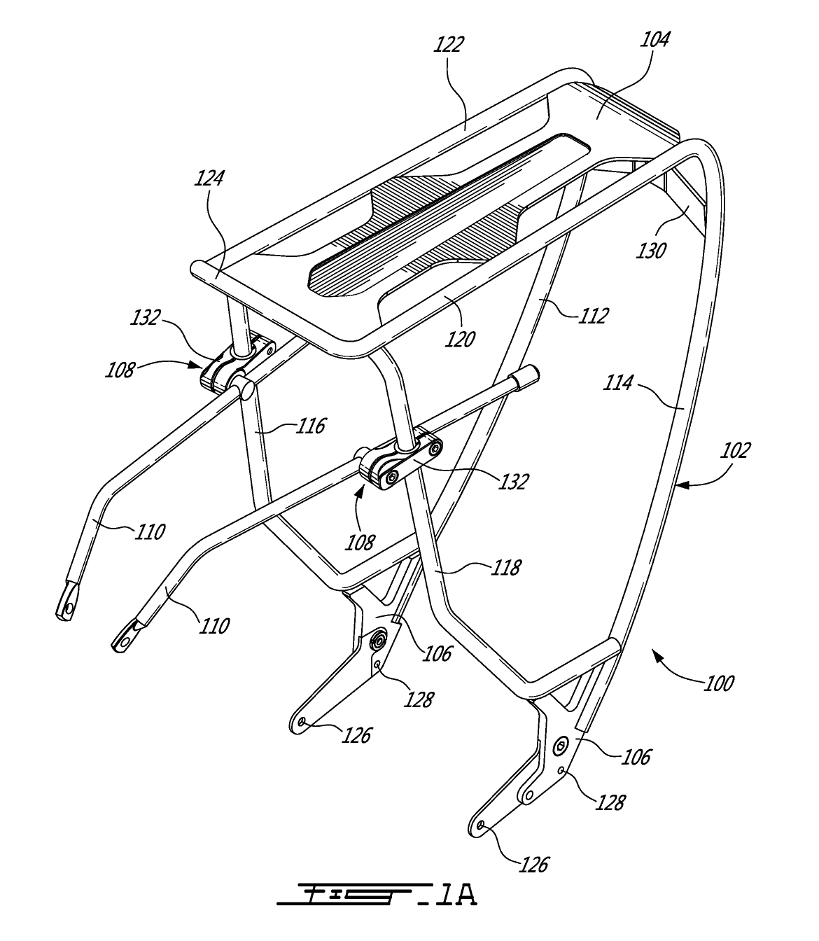

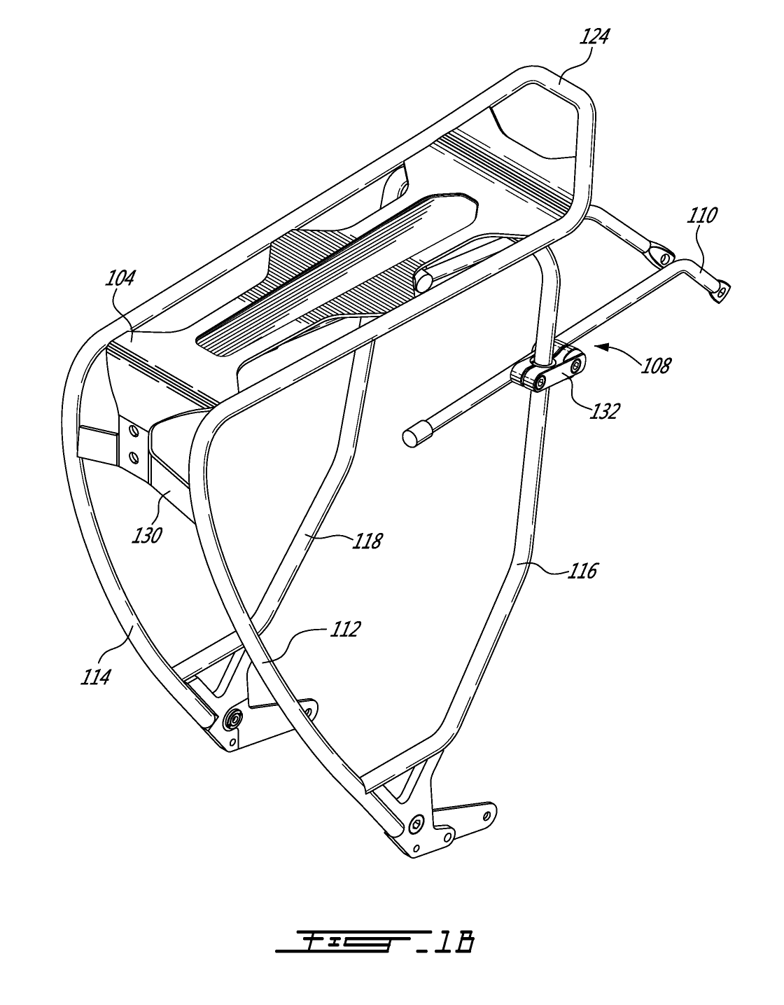

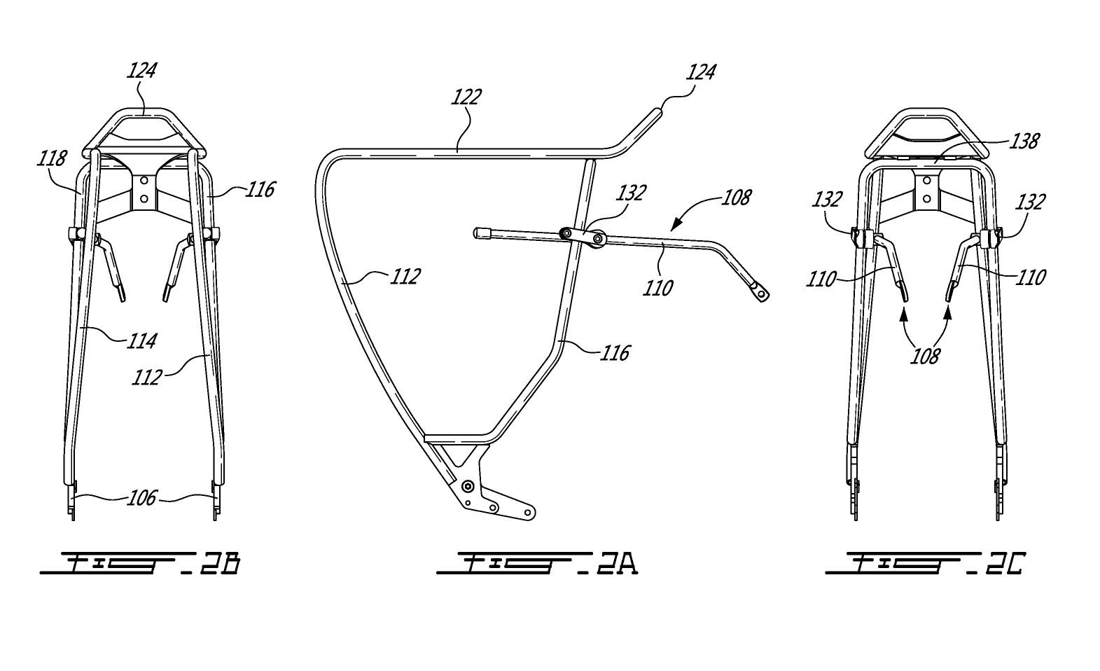

FIG. 1 and FIG. 2 show an example rear rack 100. The rear rack (also called a luggage carrier or commuting rack) is composed of four main components. The rear rack has a tube frame 102, a pannier or cargo support area or top plate 104, a dropout plate 106 provided at the bottom of each side of the frame 102 and an adjustable fixation assembly 108 provided at each side of the frame. The adjustable fixation assembly 108 includes a slider 132 and an extendable arm 110.

The tube frame 102 defines two parallel sides for the rear rack with an optional top plate. The two parallel sides are spaced apart by a width which clears the width of the wheel and the bicycle frame. The top plate 104 width is typically maximized with respect to the width of the frame. The length of the top of the frame is sized so as to receive and accommodate reasonably sized cargo or panniers. Both the width and the length of the frame can be varied depending on the needs of the bicycle owner. The proportions shown in the drawings are of an example rack with substantially standard dimensions. For example, the top surface width can be between 70 to 128 mm, and its length can be between 250 and 300 mm.

The frame 102 is typically tubular and commonly constructed from aluminum, steel or some combination of the two. For example, the tube frame can be made of AL-6061 tubular alloy of a diameter of 10.2 mm. The frame 102 can be provided with a single tube forced into the shape of the rack or can be provided by a plurality of tube sections which may be welded, riveted, or bolted together.

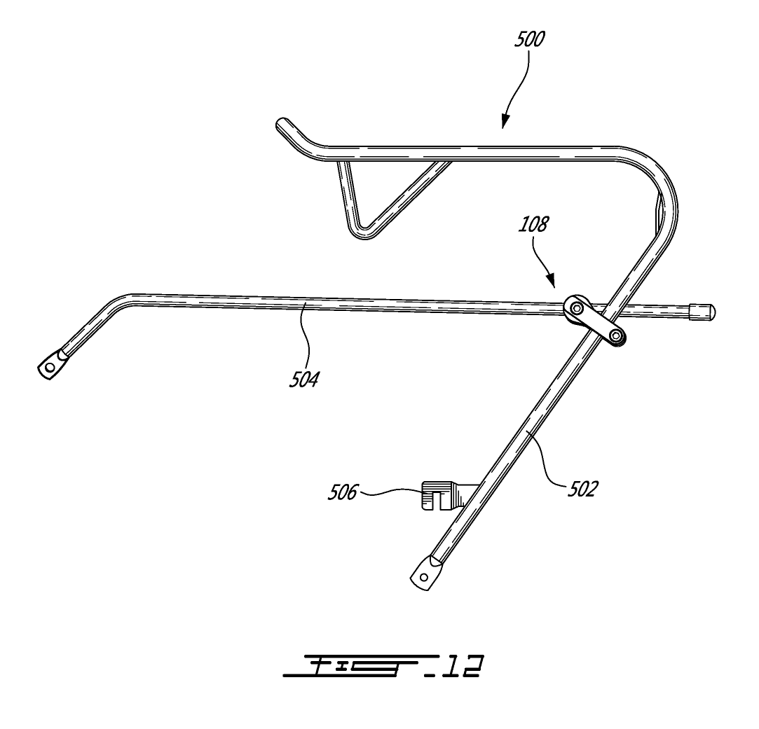

The frame 102 is composed of the following sections: the rear right-side tube 112, the rear left side tube 114, the front right-side tube 116, the front left-side tube 118, the top left side tube 120, the top right side tube 122, the front top tube 124 and the front sub-top plate tube 138 (see FIG. 2C or 2E). In the example embodiment shown, the front right side tube 116, the front sub-top plate tube 138 and the front left-side tube 118 are provided from a single tube which is curved into the appropriate shape. The rear right-side tube 112, the top right-side tube 122, the front top tube 124, the top left-side tube 120 and the rear left-side tube 114 are also provided from a single tube which is curved into the appropriate shape. As will be readily understood, some of these tube sections are optional and may be omitted (see FIG. 12 for an alternative example rear rack in which both front side tubes are omitted).

The pannier support area or top plate 104 is welded at the top of the frame 102 between the right 122 and left 120 side top tubes and may include a rear light mount 130 towards the rear of the rack. The rear light mount 130 is optional and may be absent from another configuration of the rear rack. Alternatively, the rear light mount 130 can be provided independently from the pannier top plate 204 using a rear light mount plate (not shown) provided between the right 112 and left 114 side rear tubes. As will be readily understood, depending on how the frame for the rear rack is built, the top plate 104 can be provided simply as a top area of the rear rack frame without requiring an additional welded plate. Furthermore, luggage or panniers with a rigid surface can be held on the rear rack without a specific plate at the top of the rack. Alternatively, a transversal tube can be added at the top of the rack, between the right 122 and left 120 side top tubes.

A dropout plate 106 is provided at the bottom of the rack, at the junction of the front and rear side tubes on both the left and the right sides. The dropout plate 106 is typically welded to the frame tubes. The dropout plate 106 typically bears apertures for the fixation of the rear rack to the bicycle. A wheel attachment aperture 126 is provided and an additional aperture, namely an accessory attachment aperture 128 can also be optionally provided to attach accessories, such as a fender to the rear rack. The dropout plate 106 is shaped so as to allow positioning of the rack 100 over the rear wheel (not shown) of the bicycle while allowing the top of the rack to be horizontal once the rack is securely installed. Depending on the configuration of the rack, it can allow installation of the rack behind the bicycle axle (for example 6 cm behind) for improved heel clearance, making the rack disc-brake compatible.

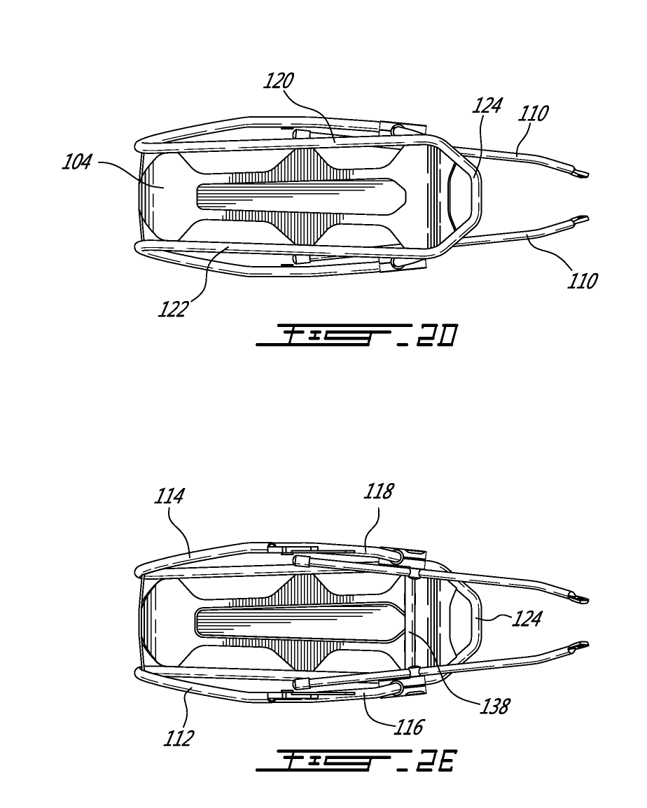

On both the front left-side tube 118 and the front right side tube 116, an adjustable fixation assembly 108 is provided. FIG. 3 shows an example adjustable fixation assembly for the rear rack of FIG. 1 in the retracted configuration. Shown in more detail in FIG. 3 is the adjustable fixation assembly 108 on the front left-side tube 118. The adjustable fixation assembly 108 comprises two main components: a slider 132 and an extendable arm 110. The slider 132 is adapted to travel upwardly and downwardly along the front tube 118. It is also adapted to rotate around the front tube 118. The extendable arm 110 has two longitudinal sections, namely a front longitudinal section 332 and a rear longitudinal section 334, provided at an angle to one another and joined at an angled section 336 of the arm 110. The longitudinal sections 332, 334 can be provided at any suitable angle to one another, in the example shown, they are provided at an angle of 135 degrees. The extendable arm 110 can be provided with a single tube forced into the shape of the angled arm 110 or can be provided by a plurality of tube sections which may be welded, riveted, or bolted together. It will be understood that the two longitudinal sections need not be provided at an angle and angled section 336 may be omitted.

The front longitudinal section 332 ends in an attachment aperture 302 provided on a flat attachment plate 338. The rear longitudinal section 334 may optionally end in a stopper 330.

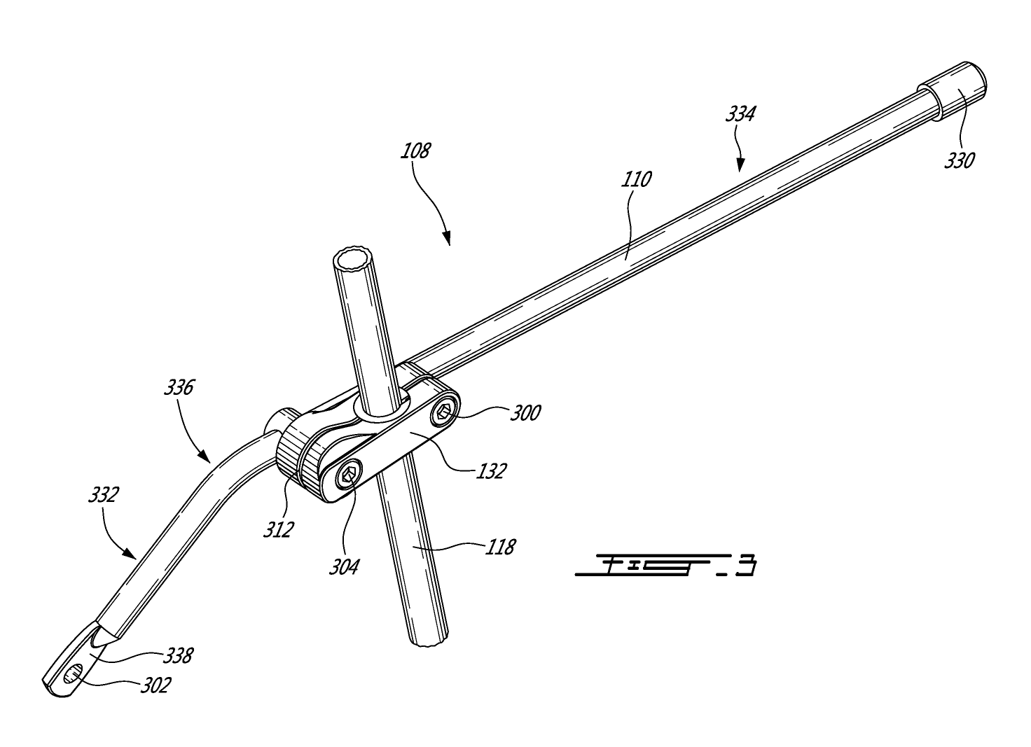

The details of the example slider 132 are shown in FIG. 4. FIG. 4 is an exploded view of the slider of the example adjustable fixation assembly of FIG. 3. The slider 132 is made of three main components: two slider body parts 306, 308 and an arm holder 328. The extendable arm 110 is received in recess 310 of the arm holder 328. Trust washer 316 facilitates rotation of the arm holder 328 with respect to the slider body part 308. It can be made of nylon. It also reduces the friction on the juxtaposed arm holder 328 and the slider body part 308 when they are tightened together. Resilient tube 314 is received within a recessed section of both slider body parts 306, 308 and surrounds the front left-side tube 118 once installed as shown in FIG. 3. Tightening screws 300, 304 are used to secure the arm holder 328 and the two slider body parts 306, 308 together through cylindrical apertures 318, 320, 322 and threaded apertures 324, 340.

During installation of the rear rack on a bicycle, the tightening screws 300 and 304 are used to secure the height of the slider along the front left-side tube 118, the extendable arm length of the extendable arm 110 with respect to the front of the rear rack 100, the angle of the recess 310 of the arm holder 328 and therefore of the extendable arm 110 with respect to the slider, the rotation angle of the extendable arm 110 within the recess 310 and the horizontal angle of the slider 132 and therefore of the extendable arm 110 with respect to the rear rack 100. When tightened sufficiently to hold the assembly 108 together, a thin slot 312 between the two body parts 306, 308 may still be visible.

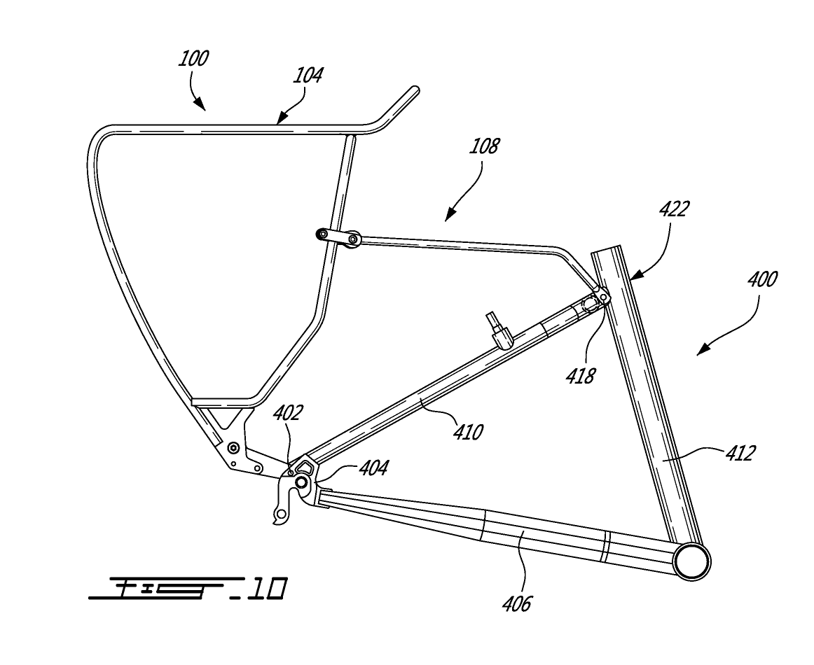

Referring back to FIG. 1 to FIG. 3, the extendable arm 110 has a length such that, in the retracted configuration, the front section 332 protrudes from the front end of the slider 132 and the angled section 336 is just in front of the front of the slider 132. The extendable arm 110 may travel within the recess 310 to an extended configuration where it protrudes fully from the front end of the slider 132 (shown in FIG. 10, for example). In order to avoid removal of the extendable arm from the adjustable fixation assembly, the extendable arm may be provided with an end-of-travel stopper 330 The tightening screw 304 is provided to increase or reduce the width of the recess 310 and therefore prevent the extendable arm 110 from traveling between the extended and retracted configurations once installed on the bicycle.

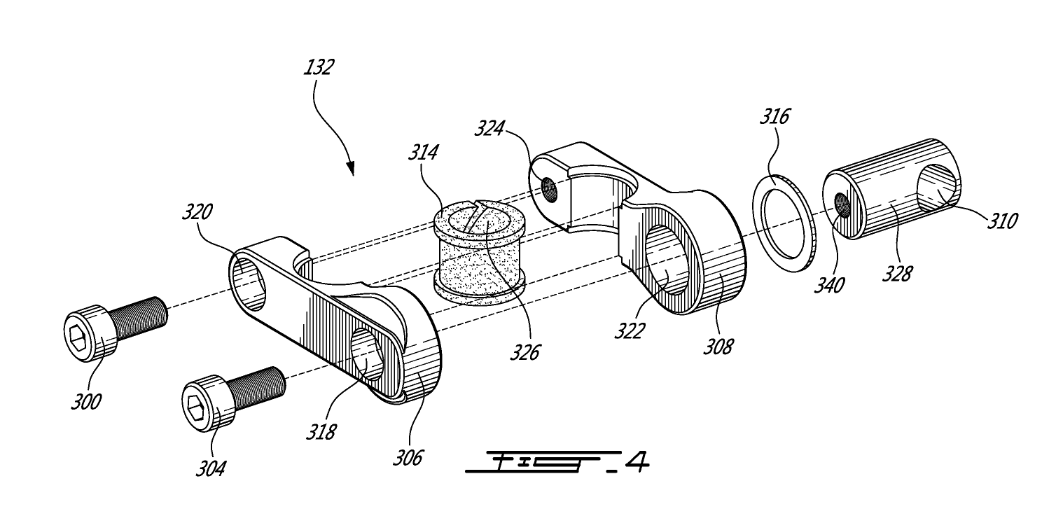

FIG. 5 shows the example rear rack of FIG. 1 on which the adjustable fixation assemblies are rotated such that the arms lie vertically. FIG. 5 shows the extendable arm 110 in an extended configuration, the slider 132 is displaced along the height of the front side tube, the extendable arm 110 has been rotated around the rotation axis of the tightening screw 304 to lie fully vertically, with the front section 332 at the bottom of the rear rack and the extendable arm 110 has been rotated along its longitudinal axis to orient the front section 332 towards the inside of the rear rack. This configuration is not typically used for installation of the rear rack on a bicycle but shows the versatility of the adjustable fixation assembly 108.

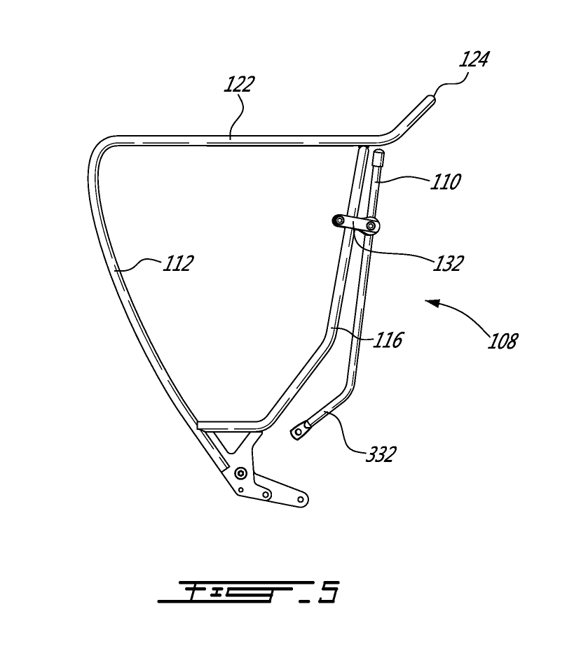

FIG. 6 shows the example rear rack of FIG. 1 on which the adjustable fixation assemblies 108 are rotated in within the frame of the rear rack 100 for packaging purposes. The front section 332 of the extendable arm is now located at the back of the rear rack 100.

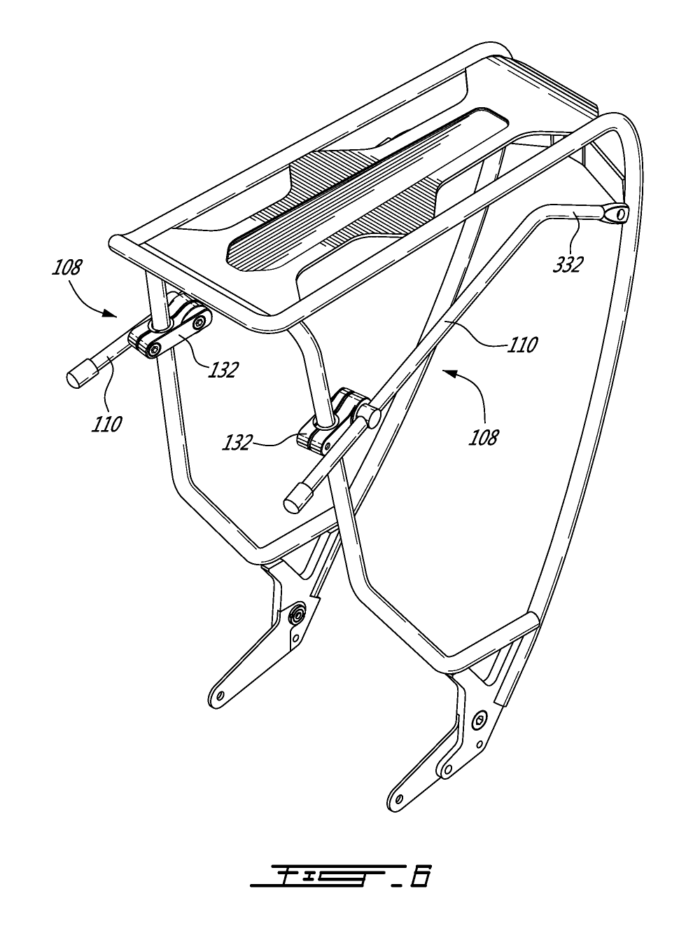

When a rear rack 100 is installed on a bicycle frame 400, it should be affixed to the bicycle frame 400 in such a manner that the top of the rack (for example the pannier support area or top plate 104 if provided) creates a horizontal surface on which to place a pannier or package. Reference will now be made to FIGS. 7 to 11 on which the rear rack 100 is shown installed on a bicycle frame 400.

Bicycle 400 typically has an eyelet 402, tapped with a standard thread, at the dropouts 404 of the rear chain stays 406. The eyelet 402 is used to affix the wheel attachment aperture 126 of the rear rack 100. Alternatively, the eyelet may be provided near the wheel hub on the seat stay (not shown). If they eyelets are non-existent, mounting the rear rack 100 is still possible but requires additional hardware (not shown). The wheel attachment aperture 126 is aligned with the eyelet 402 on the bicycle 400 and the two are screwed together in a standard fashion. The same alignment and threading is needed on both sides of the rear rack 100.

FIG. 7 shows the example rear rack 100 of FIG. 1 which is installed above the rear wheel (not shown) of a tall frame 420 of a bicycle 400 (only partly shown) using the adjustable fixation assemblies 108, in their half-extended configuration, which are attached to the eyelets 418 of the seat stays 410 of the bicycle frame 420. The seat tube 412 and the chain stay 406 are shown. The adjustable fixation assemblies 108 were positioned, extended and rotated until front sections 332 of extendable arms 110 were positioned such that their attachment aperture 302 of the flat attachment plate 338 are superposed with the eyelets 418 and the two are screwed together in a standard fashion.

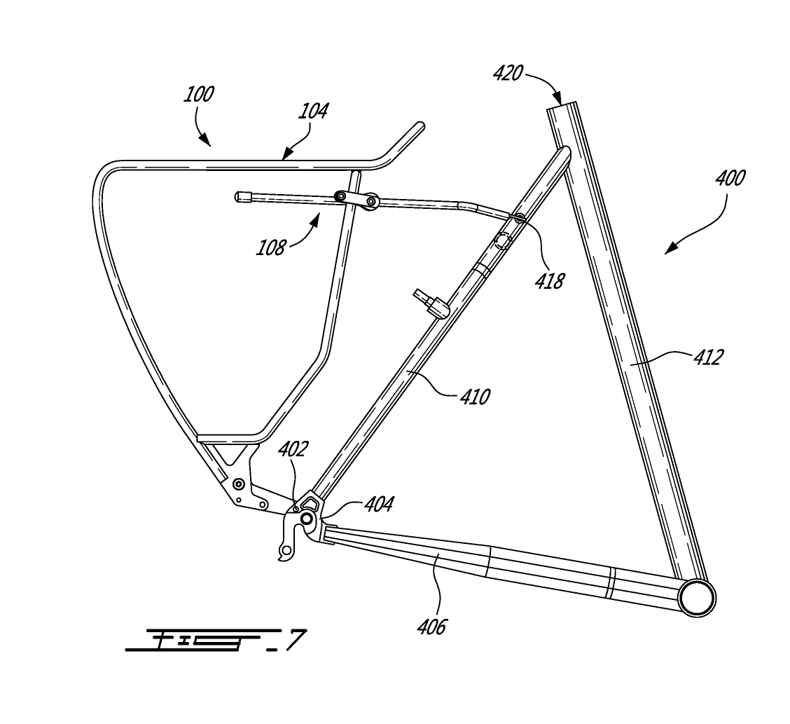

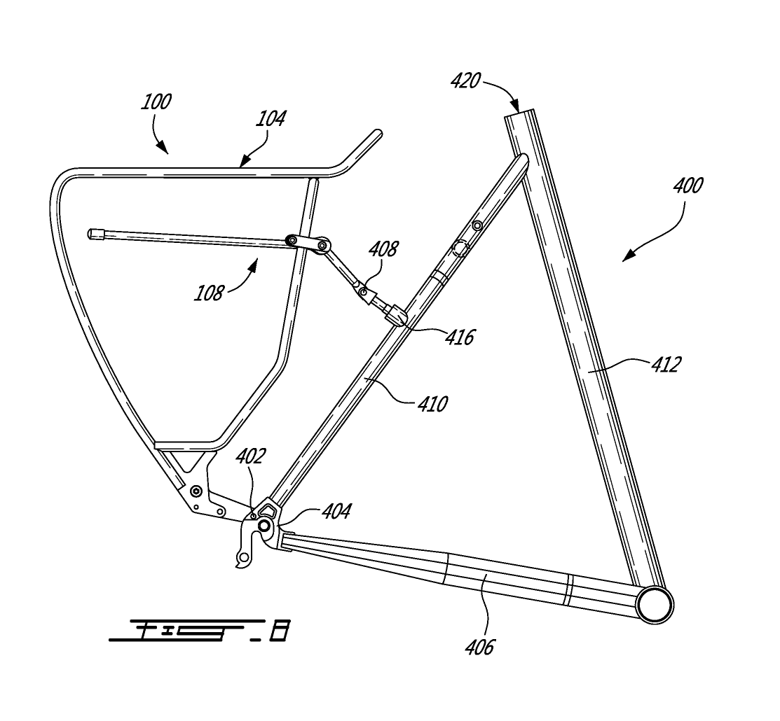

FIG. 8 shows the example rear rack 100 of FIG. 1 which is installed above the rear wheel (not shown) of a tall frame 420 of a bicycle 400 (only partly shown) using the adjustable fixation assemblies 108, in their retracted configuration, which are attached to the brake mounts 416 of the seat stays 410 of the bicycle frame 420. The seat tube 412 and the chain stay 406 are shown. The adjustable fixation assemblies 108 were positioned, extended and rotated until front sections 332 of extendable arms 110 were positioned such that their attachment aperture 302 of the flat attachment plate 338 are superposed with an attachment aperture 408 of the brake mount 416 and the two are screwed together in a standard fashion.

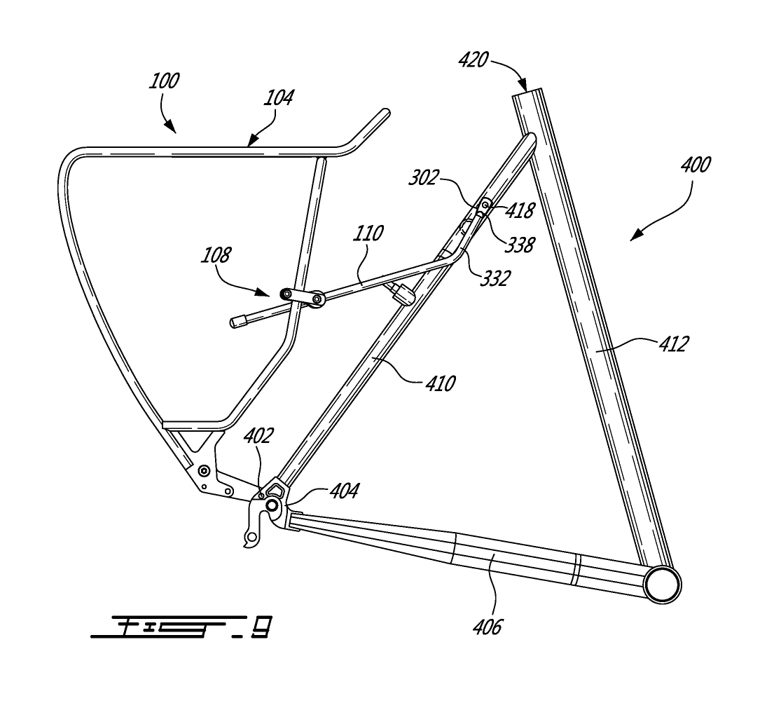

FIG. 9 shows the example rear rack 100 of FIG. 1 which is installed above the rear wheel (not shown) of a tall frame 420 of a bicycle 400 (only partly shown) using the adjustable fixation assemblies 108, in their extended configuration, which are attached to the eyelets 418 of the seat stays 410 of the bicycle frame 420. The seat tube 412 and the chain stay 406 are shown. The adjustable fixation assemblies 108 were positioned, extended and rotated until front sections 332 of extendable arms 110 were aligned somewhat parallel to seat stay 410, with the attachment aperture 302 of the flat attachment plate 338 superposed with the eyelets 418 and the two are screwed together in a standard fashion.

FIG. 10 shows the example rear rack 100 of FIG. 1 which is installed above the rear wheel (not shown) of a small frame 422 of a bicycle 400 (only partly shown) using the adjustable fixation assemblies 108, in their fully-extended configuration, which are attached to the eyelets 418 of the seat stays 410 of the bicycle frame 422. The seat tube 412 and the chain stay 406 are shown. The adjustable fixation assemblies 108 were positioned, extended and rotated until front sections 332 of extendable arms 110 were positioned such that their attachment aperture 302 of the flat attachment plate 338 are superposed with the eyelets 418 and the two are screwed together in a standard fashion.

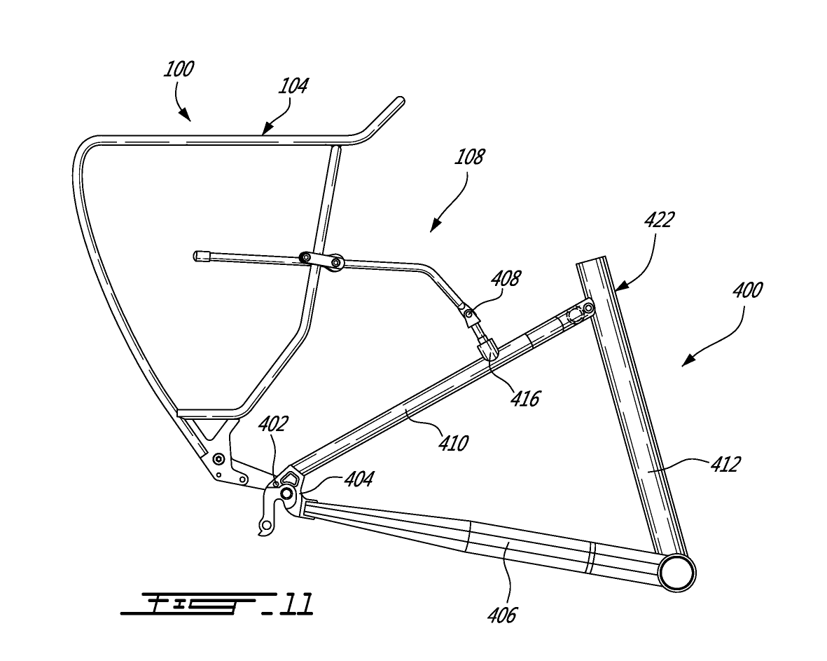

FIG. 11 shows the example rear rack of FIG. 1 which is installed above the rear wheel (not shown) of a small frame 422 of a bicycle 400 (only partly shown) using the adjustable fixation assemblies 108, in their half-extended configuration, which are attached to the brake mounts 416 of the seat stays 410 of the bicycle frame 422. The seat tube 412 and the chain stay 406 are shown. The adjustable fixation assemblies 108 were positioned, extended and rotated until front sections 332 of extendable arms 110 were positioned such that their attachment aperture 302 of the flat attachment plate 338 are superposed with an attachment aperture 408 of the brake mount 416 and the two are screwed together in a standard fashion.

Regardless of the relative distances between the rear dropout 404 of the rear wheel (not shown), the rear brake post 416, the seat stay 410, the chain stay 406 and the top tube (not shown), the installation of the rear rack 100, via the adjustable fixation assembly 108 on the rear rack frame should allow for the top of the rack to be substantially horizontal.

FIG. 12 shows another example rear rack 500 which has only two support tubes 502, one on each side of the rear rack. The adjustable fixation assemblies 108 are provided on the support tubes 502. The extendable arms 504 are shown to have a longer length than in the example embodiment of FIG. 1 to allow installation on different types and sizes of bicycles. Because there is only one tube on each side, it is the front-most tube of that side. That front-most tube receives the adjustable fixation assemblies which are used to attach the rack to the bicycle.

Also shown on FIG. 12 is a hook 506 which can be used to retain a bag provided on the rear rack. This hook 506 could be provided on any embodiment of the rear rack.

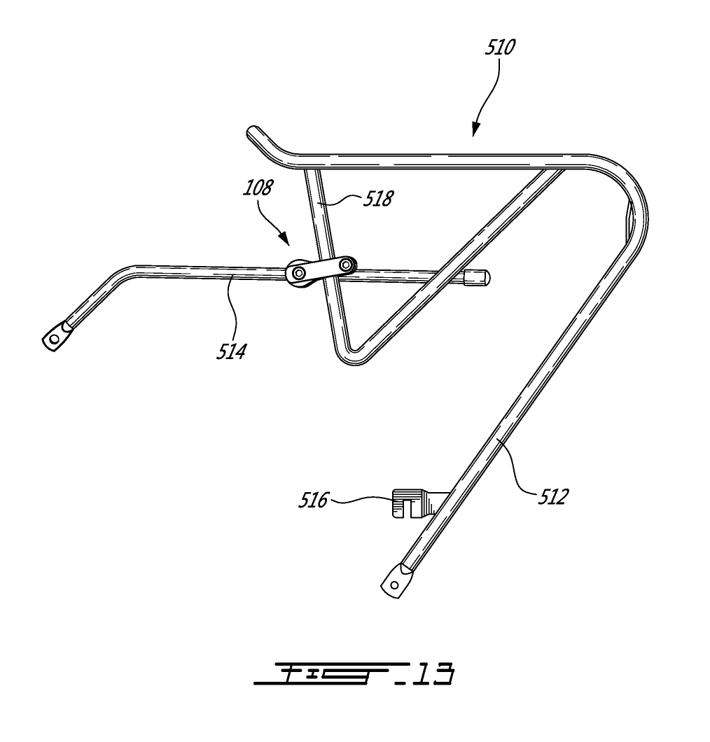

FIG. 13 shows another example rear rack 510 which has a different configuration of support tubes 518, 512, the adjustable fixation assembly 108 being provided on the front support tube of the V-shaped configuration 518. The extendable arms 514 are used to attach the rack to the bicycle. A hook 516 can be used to retain a bag provided on the rear rack.

One could envision a rear rack with a single support tube and a top plate or top tube receiving bags or panniers. A single adjustable fixation assembly of the present invention could be used on the single support tube.

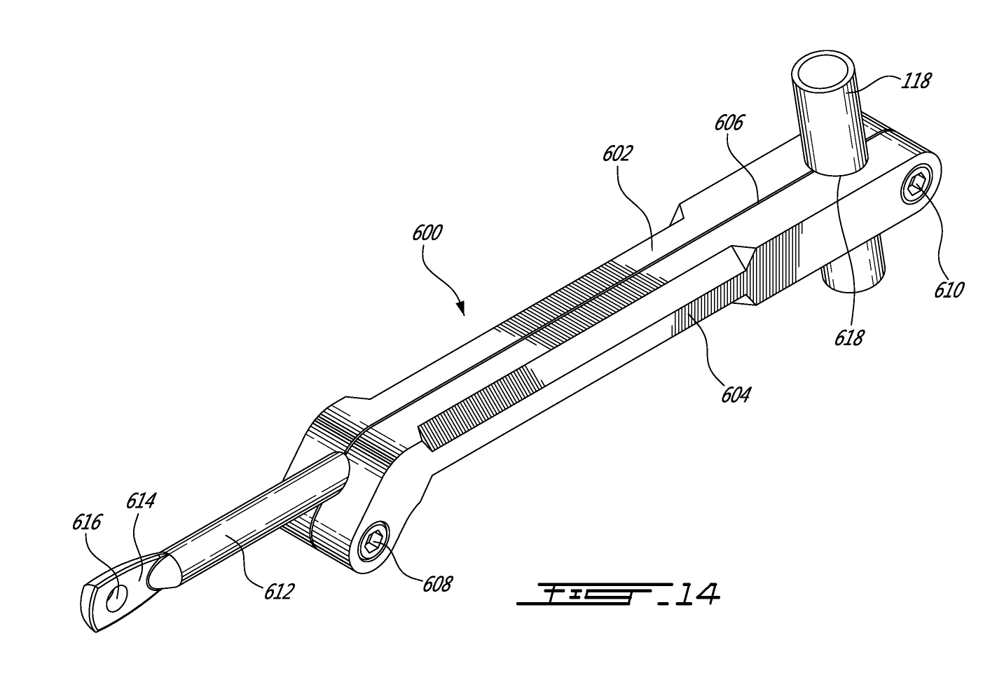

FIG. 14 shows another example adjustable fixation assembly with a telescopic arm. On both the front left-side tube 118 and the front right side tube 116, a telescopic fixation arm 600 can be provided. The telescopic fixation arm 600 is composed of two main longitudinal body parts 602, 604 which are shaped as substantially mirror images except for some fixation recesses. The two main longitudinal body parts 602, 604 are first brought together on either side of one of the front tubes 116 or 118. In the example shown, they surround front left-side tube 118. A recess 618 at one extremity of the main body part is adapted to receive a side of the tube 118. When facing each other on either side of the tube 118 or 116, the two main body parts 602, 604 are then loosely attached together using the tightening screw for the arm height 610. The tightening screw 610 allows increasing or reducing the width of the slot created between the two main longitudinal body parts 602, 604 near the front tube 118 thereby allowing moving the telescopic arm 600 along the height of the front tube for adjustment during installation.

Additionally, the main parts 602, 604 are hollowed to create a channel within the telescopic fixation arm 600. A telescopic extension tube 612 is inserted in the channel and has a length such that, in the retracted configuration, it protrudes slightly from the end of telescopic fixation arm 600 once the arm is provided on the front side tube. The extension tube 612 includes an extension attachment aperture 616 on a flat plate 614 which is adapted to be used for attachment of the telescopic arm to the bicycle. The extension tube 612 may travel within the channel to an extended or telescopic configuration where it protrudes fully from the telescopic extension arm 600. In order to avoid removal of the extension from the telescopic fixation arm, the extension may be provided with an end-of-travel protrusion which may be blocked by an end-of-travel protrusion in the channel (not shown). A tightening screw for the extension length 608 is provided to increase or reduce the width of the slot and therefore prevent the extension 612 from traveling between the extended and retracted configurations once installed on the bicycle.

Although shown with respect to the installation of a luggage carrier over a rear wheel of a vehicle, the adjustable fixation assembly of the present invention could be oriented and used to attach a luggage carrier provided over the front wheel of vehicle.

Although show with respect to the installation of a luggage carrier over a wheel of a two-wheeled vehicle, the adjustable fixation assembly of the present invention could be oriented and used to attach a luggage carrier provided over at least one wheel of three-wheeled, or four-wheeled vehicle.

The embodiments described above are intended to be exemplary only. The scope of the invention is therefore intended to be limited solely by the appended claims.

I/We claim:

1. An adjustable fixation assembly for a luggage carrier for a wheeled vehicle, the luggage carrier having at least one support tube extending at least partly between a top and a bottom of said luggage carrier, comprising:
a slider having a slider body adapted to receive a portion of said support tube, said slider being adapted to slide along a length of said support tube and to rotate about said support tube, said slider having an arm holder;
an arm being received in said arm holder of said slider, said arm being extendable between a retracted configuration and an extended configuration with respect to said support tube, a front end of said arm being adapted to be affixed to a frame of said two-wheeled vehicle;
a slider tightening assembly adapted to secure a position and orientation of said slider on said support tube;
an arm tightening assembly adapted to secure an extension length of said arm in said arm holder.

2. The adjustable fixation assembly as claimed in claim 1, wherein said arm holder is adapted to rotate about said slider body, thereby rotating said arm received in said arm holder and wherein said arm tightening assembly is also adapted to secure a rotation angle of said arm holder with respect to said slider body.

3. The adjustable fixation assembly as claimed in claim 1, wherein said arm is adapted to be rotated within said arm holder of said holder and wherein said arm tightening assembly is also adapted to secure a rotation angle of said arm within said arm holder.

4. The adjustable fixation assembly as claimed in claim 1, wherein said arm has a rear longitudinal section and a front longitudinal section, said rear and front longitudinal sections being provided at an angle to one another and joined at an angled section of the arm, said front end of said arm being provided on said front longitudinal section, said arm holder receiving said rear longitudinal section of said arm.

5. The adjustable fixation assembly as claimed in claim 1, wherein said arm has a rear end, opposed to said front end, said rear end having a stopper.

6. The adjustable fixation assembly as claimed in claim 1, further comprising a trust washer between said slider body and said arm holder.

7. The adjustable fixation assembly as claimed in claim 1, wherein said slider body includes two slider body parts.

8. The adjustable fixation assembly as claimed in claim 7, wherein said slider body further includes a resilient tube for receiving said support tube, said resilient tube being received in mirror recessed sections of said slider body parts.

9. The adjustable fixation assembly as claimed in claim 7, wherein said slider tightening assembly includes a threaded hole in one of said two slider body parts, an aligned hole in another one of said two slider body parts, said threaded hole and aligned hole being aligned when said slider body parts surround said support tube and form said slider body, and a screw being received in both said threaded hole and said aligned hole.

10. The adjustable fixation assembly as claimed in claim 7, wherein said arm tightening assembly includes a threaded hole in one of said two slider body parts, an aligned hole in another one of said two slider body parts, said threaded hole and aligned hole being aligned when said slider body parts surround said support tube and form said slider body, and a screw being received in both said threaded hole and said aligned hole.

11. The adjustable fixation assembly as claimed in claim 7, wherein said arm tightening assembly includes an intermediate hole in one of said two slider body parts, an aligned hole in another one of said two slider body parts and a threaded hole in said arm holder, said threaded hole, said intermediate hole and said aligned hole being aligned when said slider body parts surround said support tube and form said slider body and said arm holder is provided, and a screw being received in said threaded hole, said intermediate hole and said aligned hole.

12. A luggage carrier for a wheeled vehicle, comprising:
at least one support tube extending at least partly between a top and a bottom of said luggage carrier;
an adjustable fixation assembly having:
a slider having a slider body adapted to receive a portion of said support tube, said slider being adapted to slide along a length of said support tube and to rotate about said support tube, said slider having an arm holder;
an arm being received in said arm holder of said slider, said arm being extendable between a retracted configuration and an extended configuration with respect to said support tube, a front end of said arm being adapted to be affixed to a frame of said wheeled vehicle;
a slider tightening assembly adapted to secure a position and orientation of said slider on said support tube;
an arm tightening assembly adapted to secure an extension length of said arm in said arm holder.

13. The luggage carrier as claimed in claim 12, wherein said at least one support tube is four support tubes, wherein two of said adjustable fixation assembly are provided on two of said four support tube, wherein said luggage carrier has a top surface, wherein said four support tubes end in two parallel dropout plates for attachment of a bottom of said luggage carrier near a wheel of said wheeled vehicle.
